(19) United States
(12) Patent Application Publication
(10) Pub. No.: US 2007/0196241 A1
(43) Pub. Date: Aug. 23, 2007

(54) LIQUID CONTAINER

(76) Inventor: Hitotoshi Kimura, Matsumoto-shi (JP)

Correspondence Address: STROOCK & STROOCK & LAVAN LLP, 180 MAIDEN LANE, NEW YORK, NY, 10038, US

(21) Appl. No.: 11/675,277

(22) Filed: Feb. 15, 2007

(30) Foreign Application Priority Data
Dec. 15, 2006 (JP) 2006-038578
Feb. 17, 2006 (JP) 2006-041289

(51) Int. Cl. B01L 3/00

(52) U.S. Cl. 422/102

(57) ABSTRACT

A liquid container includes: a liquid containing chamber that discharges a liquid stored therein from a liquid discharge port by pressurization of a pressure unit; a liquid detection chamber that is disposed in a region where a pressure is applied by the pressure unit and is connected to the liquid containing chamber, a volume of the liquid detection chamber being increased according to an inflow of the liquid from the liquid containing chamber and being reduced when the inflow of the liquid from the liquid containing chamber stops; a detection unit for detecting a change of the volume of the liquid detection chamber; and a valve mechanism that is disposed between the liquid containing chamber and the liquid detection chamber and can block an inflow of the liquid from the liquid containing chamber to the liquid detection chamber.

### BACKGROUND

1. Technical Field

The present invention relates to a liquid container, and in particular, to a liquid container that supplies a liquid, such as ink or the like, to a liquid consuming apparatus, for example, a liquid jetting head ejecting a minute amount of liquid droplet.

2. Related Art

A liquid ejection head of a textile printing apparatus, a micro dispenser, or a commercial recording apparatus that requires ultrahigh printing quality receives a liquid ejected from a liquid container that is detachably mounted on an apparatus main body. However, in order to prevent the liquid ejection head from being damaged due to idle printing, it is necessary to monitor a liquid residual quantity in the container.

There are suggested various methods that detect an ink residual quantity of an ink cartridge as a liquid container used in a recording apparatus.

As the liquid container that can detect the liquid residual quantity, there is known a liquid container having the following configuration. The liquid container includes a liquid containing chamber that discharges the liquid stored therein to a liquid detection chamber by pressurization of a pressure unit, and a detection unit that is disposed in a region to be blocked from a pressure of the pressure unit so as to detect a change of volume of the liquid detection chamber (for example, see Patent Document 1).

In the liquid detection chamber, for example, a part of a sensor chamber is formed of a flexible film or the like. Even though a sufficient liquid residual quantity exists in the liquid containing chamber, when the liquid containing chamber is not pressurized by the pressure unit and then the liquid is not discharged from the liquid containing chamber, the volume of the liquid detection chamber is minimized. Then, if the liquid is discharged from the liquid containing chamber by the pressurization of the pressure unit, the volume of the liquid detection chamber increases according to the amount of the discharged liquid.

Meanwhile, when the pressurization of the pressure unit is performed, the amount of the liquid to be discharged from the liquid containing chamber gradually decreases according to a decrease in the liquid residual quantity of the liquid containing chamber. If the amount of the liquid to be discharged from the liquid containing chamber decreases, the increase in volume of the liquid detection chamber decreases accordingly.

Then, the detection unit can detect whether or not a liquid containing amount of the liquid detection chamber reaches to a predetermined level at the time of the pressurization of the pressure unit.

Patent Document 1:JP-A-2004-351871

In the above-described liquid container, when the liquid is not discharged from the liquid containing chamber, the flexible film that constitutes a part of the sensor wall is urged by an appropriate urging unit in a direction in which the volume of the liquid detection chamber is reduced, such that the liquid detection chamber is kept to the minimum volume. Then, whenever ink is discharged from the liquid containing chamber and the volume of the liquid detection chamber increases, the flexible film repeats deformation to expand the volume of the liquid detection chamber. Accordingly, the flexible film needs to be formed of an expensive material having high durability, which causes an increase in manufacturing cost of the liquid container.

In order to increase durability of the flexible film, if the thickness of the flexible film becomes thicker, the flexible film cannot be easily deformed. Accordingly, there is a possibility that the flexible film cannot smoothly follow the change of the volume of the liquid detection chamber.

### SUMMARY

An advantage of an aspect of the invention is to provide an inexpensive liquid container in which a volume of a liquid detection chamber does not repeatedly change and durability of a flexible film does not need to be increased. The advantage can be attained by at least the following aspect:

According to an aspect of the invention, there is provided a liquid container comprising: a liquid containing chamber that discharges a liquid stored therein from a liquid discharge port by pressurization of a pressure unit; a liquid detection chamber that is disposed in a region where a pressure is applied by the pressure unit and is connected to the liquid containing chamber, a volume of the liquid detection chamber being increased according to an inflow of the liquid from the liquid containing chamber and being reduced when the inflow of the liquid from the liquid containing chamber stops; a detection unit for detecting a change of the volume of the liquid detection chamber; and a valve mechanism that is disposed between the liquid containing chamber and the liquid detection chamber and can block an inflow of the liquid from the liquid containing chamber to the liquid detection chamber.

With this configuration, when a sufficient liquid residual quantity exists in the liquid containing chamber, the volume of the liquid detection chamber is increasing regardless of pressurization or unpressurization by the pressure unit. Accordingly, the volume of the liquid detection chamber is reduced from a time when the inflow of the liquid from the liquid containing chamber stops, that is, when the liquid is exhausted.

Accordingly, even though pressurization or unpressurization to the liquid containing chamber by the pressure unit is repeated according to the supply of the liquid, the volume of the liquid detection chamber is not reduced, and the volume of the liquid detection chamber does not repeatedly change.

Therefore, in a flexible film that constitutes a part of a sensor chamber, wear due to a repetitive change is prevented.

Further, when the valve mechanism that is disposed between the liquid containing chamber and the liquid detection chamber is closed, the inflow of the liquid from the liquid containing chamber is blocked, and thus the liquid containing chamber can become a pseudo liquid exhaustion state. Therefore, the volume of the liquid detection chamber can be reduced.

Accordingly, in the liquid container in which the liquid containing chamber and the liquid detection chamber are pressurized simultaneously, while the liquid consuming apparatus is used, if the liquid container becomes the pseudo ink exhaustion state, the change of the volume of the liquid detection chamber can be detected by the detection unit. Therefore, the malfunction of the detection unit can be checked.

That is, in a state where the valve mechanism is closed and a state where the valve mechanism is opened, the detection unit can detect the volume of the liquid detection chamber. Therefore, it is possible to detect presence/absence of the liquid in the liquid containing chamber and the malfunction of the detection unit.

In the liquid container according to the aspect of the invention, the valve mechanism may include a valve chamber that communicates an inlet port communicating with the liquid containing chamber with an outlet port communicating with the liquid detection chamber, and a diaphragm that defines the valve chamber and is deformable by an external force. The outlet port that is formed in the valve chamber may be closed by deformation of the diaphragm.

With this configuration, the diaphragm can be easily deformed by causing the external force to act on the diaphragm. Accordingly, the diaphragm comes into close contact with the outlet port formed in the valve chamber by the deformed diaphragm and a negative pressure of the liquid detection chamber through the suction of the liquid from the supply port. Therefore, the outlet port can be reliably closed.

In the liquid container according to the aspect of the invention, the valve mechanism may be disposed in a region that is blocked from a pressure of the pressure unit, and the outlet port formed in the valve chamber may be closed by the deformation of the diaphragm according to a negative pressure of the valve chamber generated through suction of the liquid from the supply port.

With this configuration, the pressure applied to the liquid containing chamber by the pressure unit does not act on the valve mechanism. Accordingly, the outlet port can be closed by setting the valve chamber communicating with the liquid detection chamber through the outlet port to the negative pressure and causing the diaphragm to be deformed by the negative pressure. That is, it is not necessary to separately provide a mechanism for applying the external force in the diaphragm, and thus the valve mechanism can be simply configured.

In the liquid container according to the aspect of the invention, the outlet port that is formed in the valve chamber may have an opening area larger than that of the inlet port that is formed in the valve chamber.

With this configuration, a large suction force acts on the valve chamber. Accordingly, the valve chamber is in the negative pressure state, and thus the suction of the diaphragm is reliably performed. That is, the outlet port can be reliably closed.

In the liquid container according to the aspect of the invention, the outlet port that is formed in the valve chamber may be disposed to face a maximum displacement portion of the diaphragm.

With this configuration, since the outlet port is disposed to face the maximum displacement portion of the diaphragm, the outlet port can be reliably closed at a small negative pressure. Further, since a distance between the outlet port and the diaphragm can be set to be long in a normal state, flow passage resistance in that region can be made small.

In the liquid container according to the aspect of the invention, the liquid detection chamber may be configured by sealing an opening of a concave space provided in a member forming the liquid detection chamber with a film that is deformable according to a liquid containing amount.

With this configuration, the liquid detection chamber can be formed by a simple manufacturing process of sealing the opening of the concave space with the film through thermal welding. Therefore, an airtight liquid detection chamber can be easily manufactured.

In the liquid container according to the aspect of the invention, the diaphragm may be formed of a deformable film that seals an opening of a concave place provided in a member forming the valve chamber.

With this configuration, the valve chamber can be formed by a simple manufacturing process of sealing the opening of the concave place with the film through thermal welding. Therefore, an airtight valve chamber can be easily manufactured.

In the liquid container according to the aspect of the invention, the detection unit may include a moving member that is accommodated to move according to the liquid containing amount of the liquid detection chamber, a recess portion that, if the liquid containing amount of the liquid detection chamber becomes a predetermined amount or less, defines a detection space in cooperation with a surface of the moving member, and a piezoelectric detection unit that applies vibration to the recess portion and detects a free vibration state according to the applied vibration.

With this configuration, if the liquid containing amount in the liquid detection chamber becomes a predetermined amount or less, the moving member defines the detection space in cooperation with the recess portion serving as a vibration reaction region. Accordingly, a change of the free vibration state markedly appears, and thus a time or state where the liquid containing amount in the liquid detection chamber reaches a predetermined level can be accurately and reliably detected.

According to the liquid container of the aspect of the invention, even though pressurization or unpressurization to the liquid containing chamber by the pressure unit is repeated according to the supply of the liquid, the volume of the liquid detection chamber is not reduced, and the volume of the liquid detection chamber does not repeatedly change.

Accordingly, in a flexible film that constitutes a part of a sensor chamber, wear due to a repetitive change is prevented.

Therefore, since it is not necessary to form the flexible film of an expensive material having high durability, an increase in cost of the liquid container can be prevented. In addition, since it is not necessary to form the flexible film thicker in order to increase durability of the flexible film, the flexible film can be easily deformed.

Further, when the valve mechanism that is disposed between the liquid containing chamber and the liquid detection chamber is closed, the inflow of the liquid from the liquid containing chamber is blocked, and thus the liquid containing chamber can become a pseudo liquid exhaustion state. Therefore, the volume of the liquid detection chamber can be reduced.

Accordingly, in the liquid container in which the liquid containing chamber and the liquid detection chamber are pressurized simultaneously, while the liquid consuming apparatus is used, if the liquid container becomes the pseudo ink exhaustion state, the change of the volume of the liquid detection chamber can be detected by the detection unit. Therefore, the malfunction of the detection unit can be checked.

The present disclosure relates to the subject matter contained in Japanese patent application Nos. 2006-038578 filed on Feb. 15, 2006 and 2006-041289 filed on Feb. 17, 2006, which are expressly incorporated herein by reference in its entirety.

### BRIEF DESCRIPTION OF THE DRAWINGS

The invention will be described with reference to the accompanying drawings, wherein like numbers reference like elements.

FIG. 1 is a longitudinal cross-sectional view of a liquid container according to a first embodiment of the invention.

FIG. 2 is a longitudinal cross-sectional view showing a case where an inlet port and an outlet port of the liquid container shown in FIG. 1 are closed.

FIG. 3 is a longitudinal cross-sectional view of a liquid container when an on/off valve mechanism is closed and the liquid container becomes a pseudo liquid exhaustion state.

FIG. 4 is a longitudinal cross-sectional view of a liquid container according to a second embodiment of the invention.

### DESCRIPTION OF EXEMPLARY EMBODIMENTS

Hereinafter, preferred embodiments of a liquid container according to the invention will be described in detail with reference to the accompanying drawings.

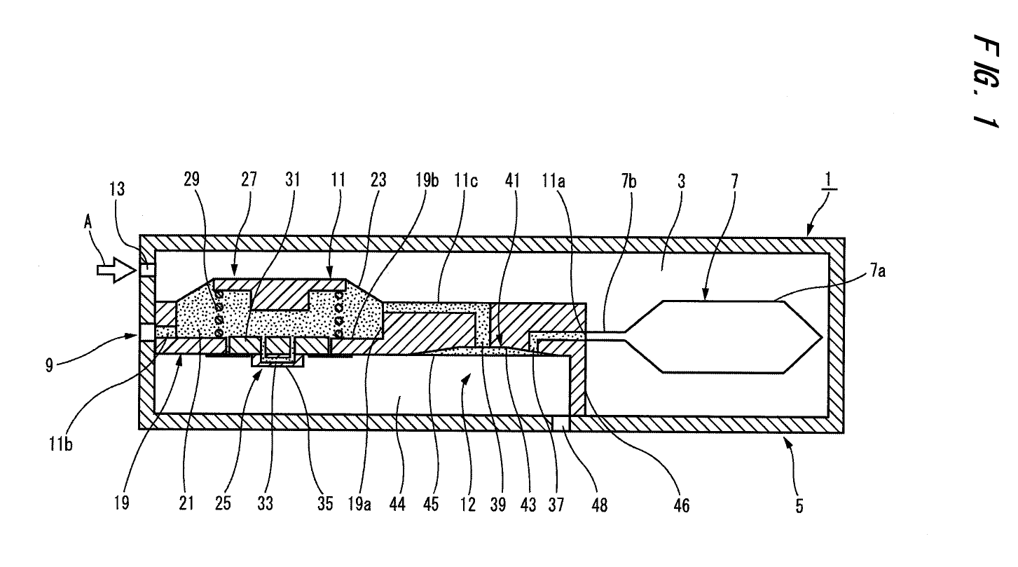

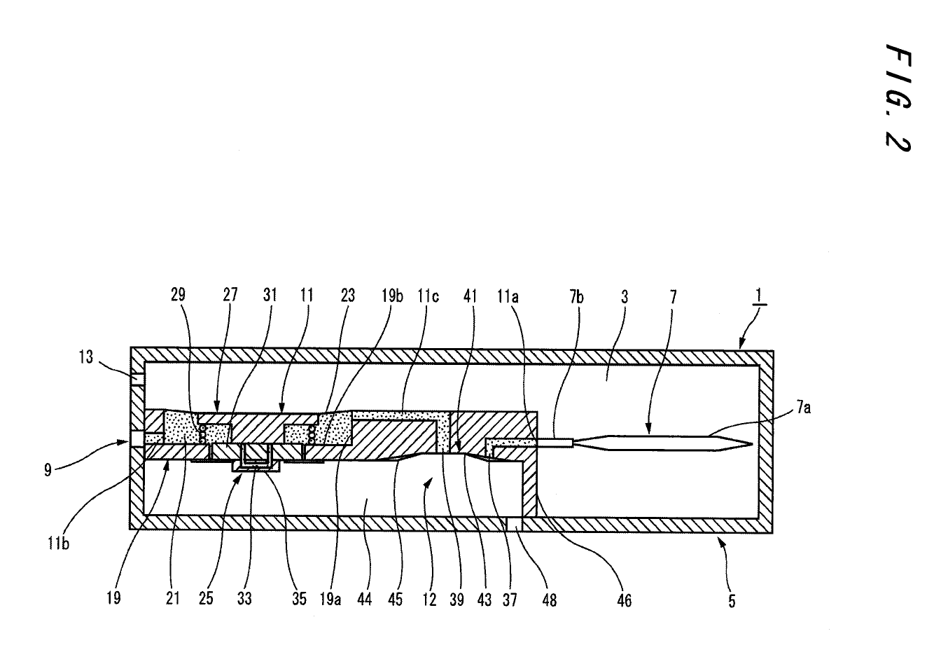

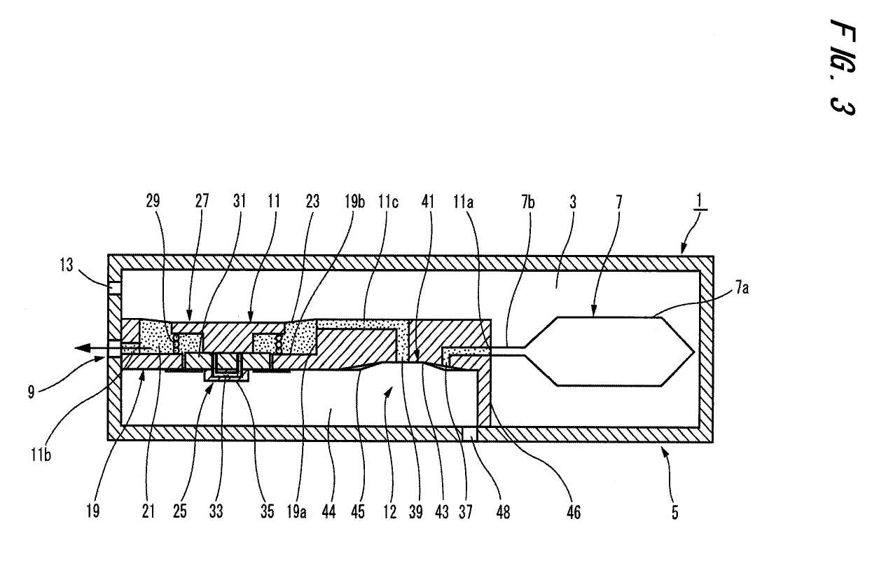

FIG. 1 is a longitudinal cross-sectional view of a liquid container according to a first embodiment of the invention. FIG. 2 is a longitudinal cross-sectional view showing a case where an inlet port and an outlet port of the liquid container shown in FIG. 1 are closed. FIG. 3 is a longitudinal cross-sectional view of a liquid container when an on/off valve mechanism is closed and the liquid container becomes a pseudo liquid exhaustion state.

A liquid container 1 according to the first embodiment is an ink cartridge that is detachably mounted on a cartridge mounting portion of an ink jet recording apparatus (liquid consuming apparatus) (not shown) and supplies ink (liquid) to a printing head provided in the recording apparatus.

As shown in FIG. 1, the liquid container 1 includes a container main body 5 that defines a pressure chamber 3 to be pressurized by a pressure unit (not shown), an ink pack (liquid containing chamber) 7 that stores ink, is accommodated in the pressure chamber 3, and discharges ink stored therein from a discharge port (liquid discharge port) 7b by pressurization of the pressure chamber 3, a liquid supply port (supply port) 9 through which ink is supplied to a printing head of an ink jet recording apparatus as an external liquid consuming apparatus, an ink detection unit (detection unit) 11 that is interposed between the ink pack 7 and the ink supply port 9 so as to detect an ink residual quantity, and an on/off valve mechanism 12 (valve mechanism) that is disposed between the ink pack 7 and the ink detection unit 11 so as to block an inflow of ink from the ink pack 7 to the ink detection unit 11.

The container main body 5 has the airtight pressure chamber 3, a pressure port 13 serving as a pressurized gas injection portion, through which the pressure unit (not shown) supplies pressurized air to the pressure chamber 3 as indicated by an arrow A, and a space 44 that is exposed to the atmosphere.

The pressure chamber 3 is a region where the pressure of the pressurized gas to be supplied by the pressure unit is applied. Accordingly, the pressure applied from the pressure unit acts on both the ink pack 7 accommodated in the pressure chamber 3 and the ink detection unit 11.

The ink pack 7 has a flexible pouch body 7a formed by adhering edges of aluminum-laminated multilayer films, on which an aluminum layer is laminated on a flexible resin film layer, to each other. A cylindrical discharge port 7b, to which an ink inlet port (liquid inlet port) 11a of the ink detection unit 11 is connected, is bonded to one end of the pouch body 7a. Since the ink pack 7 uses the aluminum-laminated multilayer films, a high gas barrier property is secured.

The ink pack 7 and the ink detection unit 11 are connected to each other by engaging the ink inlet port 11a with the discharge port 7b. That is, the ink pack 7 and the ink detection unit 11 can be detached from each other by releasing the engagement of the discharge port 7b and the ink inlet port 11a.

Moreover, in the discharge port 7b, a packing that connects the discharge port 7b and the ink inlet port 11a airtight is provided. Then, ink is filled into the ink pack 7 in advance at a high degree of deaeration before the ink detection unit 11 is connected to the ink pack 7.

The ink detection unit 11 includes a detection unit case 19 that has a concave space 19a communicating the ink inlet port 11a connected to the discharge port 7b of the ink pack 7 and an ink outlet port (liquid outlet port) 11b connected to the ink supply port 9, a flexible film 23 that seals an opening of the concave space 19a so as to define a sensor chamber (liquid detection chamber) 21, a pressure detection unit 25 that is provided at a bottom 19b of the concave space 19a, a pressure receiving plate (moving member) 27 that is fixed to the flexible film 23 to face the pressure detection unit 25, and a compressed coil spring (urging unit) 29 that is provided between the pressure receiving plate 27 and the bottom 19b in a compressed state and elastically urges the pressure receiving plate 27 and the flexible film 23 in a direction in which the volume of the sensor chamber 21 is increased.

The sensor chamber 21 is preferably configured by sealing the opening of the concave space 19a provided in the detection unit case 19 as a member forming the sensor chamber 21 with the flexible film 23. The flexible film 23 functions as a diaphragm that applies displacement to the pressure receiving plate 27 according to the pressure of ink to be supplied to the sensor chamber 21. In order to enable detection of a slight change of pressure of ink and to improve detection accuracy, what is necessary is that the flexible film 23 has enough flexibility. With this configuration, the sensor chamber 21 can be formed by a simple manufacturing process of sealing the opening of the concave space 19a with the flexible film 23 using thermal welding. Accordingly, the airtight sensor chamber 21 can be easily manufactured.

In the detection unit case 19, an ink discharge path 11c is integrally formed at one end of a peripheral wall defining the concave space 19a, and the ink outlet port 11b that communicates with the ink supply port 9 is formed to pass through a peripheral wall facing the ink discharge path 11c. Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

The pressure detection unit 25 of the ink detection unit 11 includes a bottom plate 31 that is separated from the pressure receiving plate 27 by an urging force of the compressed coil spring 29 when ink is not deduced from the ink pack 7 to the ink supply port 9, an ink guide path 33 that is a recess portion formed in the bottom plate 31, and a piezoelectric sensor (piezoelectric detection unit) 35 that applies vibration to the ink guide path 33 and detects a free vibration state according to the applied vibration.

The piezoelectric sensor 35 can detect different free vibration states (amplitude of residual vibration or change of frequency) according to whether or not the ink guide path 33 is covered with the pressure receiving plate 27.

Accordingly, for example, a control unit provided in the ink jet recording apparatus can detect deformation of the flexible film 23 supporting the pressure receiving plate 27 according to the free vibration state detected by the piezoelectric sensor 35, thereby detecting a change of the volume of the sensor chamber 21.

An urging direction of the compressed coil spring 29 is a direction in which the volume of the sensor chamber 21 is increased, as described above. Accordingly, in a normal state (in a state where ink of the ink pack 7 is not exhausted), as shown in FIG. 1, the pressure receiving plate 27 and the bottom plate 31 are separated from each other.

When a sufficient ink residual quantity exists in the ink pack 7, the separation state is kept even though the pressure by the pressure unit is applied to the pressure chamber 3. That is, the compressed coil spring 29 has an urging force that separates the pressure receiving plate 27 from the bottom 19b against the pressure by the pressure unit in cooperation with an inflow pressure of ink flowing from the ink pack 7 to the sensor chamber 21 by the pressurization of the pressure unit.

Meanwhile, as shown in FIG. 2, when ink of the ink pack 7 is exhausted, and the inflow of ink from the ink pack 7 stops or ink is absorbed from the ink supply port 9, the pressure receiving plate 27 moves against the urging force of the compressed coil spring 29 and comes into close contact with the bottom plate 31 by a negative pressure in the sensor chamber 21.

The ink guide path 33, which is the recess portion formed in the bottom plate 31, defines a detection space in cooperation with the pressure receiving plate 27 in a state where the pressure receiving plate 27 comes into close contact with the bottom plate 31, as shown in FIG. 2. Further, in a state where the pressure receiving plate 27 is separated from the bottom plate 31, the ink guide path 33 is opened and communicates with the sensor chamber 21. The pressure receiving plate 27 has, in a region facing a vibration surface of the piezoelectric sensor 35, a surface substantially parallel to the vibration surface.

In the ink detection unit 11, if ink is supplied from the ink pack 7 to the sensor chamber 21 by pressurization of the ink pack 7 due to pressurized air to be supplied to the pressure chamber 3, the inflow pressure of ink deforms the flexible film 23 to be swelled upward in cooperation with the urging force of the compressed coil spring 29 If the pressure receiving plate 27 is separated from the bottom plate 31, the ink guide path 33 is opened and communicates with the sensor chamber 21, and thus ink is supplied from the ink supply port 9 to the printing head through the sensor chamber 21.

Even if the pressure chamber 3 is in a predetermined pressurization state, when ink contained in the ink pack 7 decreases, the amount of ink to be supplied from the ink pack 7 to the sensor chamber 21 decreases. Then, since the pressure of the sensor chamber 21 decreases, the pressure receiving plate 27 approaches the bottom plate 31 having the ink guide path 33.

That is, if the liquid containing amount in the sensor chamber 21 is a predetermined amount or less, the pressure receiving plate 27 defines the detection space in cooperation with the ink guide path 33 as a vibration reaction region. Accordingly, a change of free vibration state to be detected by the piezoelectric sensor 35 markedly appears, and thus a time or state where the liquid containing amount in the sensor chamber 21 reaches a predetermined level can be accurately and reliably detected. In this embodiment, a time at which the pressure receiving plate 27 comes into close contact with the bottom plate 31 by the decrease in pressure of the sensor chamber 21 and defines the detection space in cooperation with the ink guide path 33 is set to a state where ink of the ink pack 7 is exhausted.

The on/off valve mechanism 12 is disposed between the ink pack 7 and the ink detection unit 11 and blocks the inflow of ink from the ink pack 7 to the ink detection unit 11. The on/off valve mechanism 12 has a valve chamber 41 that causes an inlet port 37 communicating with the ink pack 7 to communicate with an outlet port 39 communicating with the sensor chamber 21. The inlet port 37 communicates with the ink pack 7 through the liquid inlet port 11a. The outlet port 39 communicates with the sensor chamber 21 through the ink discharge path 11c.

The valve chamber 41 is configured by sealing an opening of a concave place 43 provided in the detection unit case 19 as a member forming the valve chamber 41 with a diaphragm 45. With this configuration, the valve chamber 41 can be formed by a simple manufacturing process of sealing the opening of the concave place 43 with the diaphragm 45 through thermal welding. Accordingly, the airtight valve chamber 41 can be easily manufactured.

The diaphragm 45 is formed of a deformable film. The inlet port 37 and the outlet port 39 formed in the valve chamber 41 can be closed by the deformation (close adhesion) of the diaphragm 45. A space 44, in which the diaphragm 45 is disposed, is defined by the pressure chamber 3 and a partition wall 46. The space 44 communicates with the atmosphere through an opening 48.

In this embodiment, the outlet port 39 formed in the valve chamber 41 is closed by the deformation of the diaphragm 45 due to a negative pressure of the valve chamber 41 generated through the suction of ink from the ink supply port 9. That is, the outlet port 39 can be closed by setting the valve chamber 41 communicating with the sensor chamber 21 through the outlet port 39 to have a negative pressure by ink of the sensor chamber 21 to be absorbed from the ink supply port 9 and causing the diaphragm 45 to be deformed by the negative pressure.

Specifically, it is not necessary to separately provide a mechanism for applying an external force in the diaphragm 45, and thus the on/off valve mechanism 12 can be simply configured.

The outlet port 39 formed in the valve chamber 41 has preferably an area larger than that of the inlet port 37 formed in the valve chamber 41. Accordingly, a large suction force acts on the valve chamber 41. Therefore, the valve chamber 41 is set to the negative pressure, and thus the suction of the diaphragm 45 is reliably performed, that is, the outlet port 39 can be reliably closed.

The outlet port 39 formed in the valve chamber 41 is disposed to face a maximum displacement portion of the diaphragm 45 (a central portion of the diaphragm 45). Accordingly, the diaphragm 45 can be reliably displaced at a small negative pressure, and the outlet port 39 can be reliably closed. Further, since a distance between the outlet port 39 and the diaphragm 45 can be set to be long in a normal state, flow passage resistance in that region can be made small.

Accordingly, as shown in FIG. 3, when the outlet port 39 is closed by setting the valve chamber 41 to the negative pressure through the suction of ink from the ink supply port 9, the inflow of ink from the ink pack 7 is blocked. In this state, if ink is further absorbed from the ink supply port 9, the pressure in the sensor chamber 21 decreases, and thus the pressure receiving plate 27 approaches the bottom plate 31 and finally comes into close contact with the bottom plate 31.

That is, if the on/off valve mechanism 12 blocks the conduction to the ink pack 7, the ink pack 7 can become a pseudo ink exhaustion state. Thereafter, if the pressure chamber 3 is pressurized, the on/off valve mechanism 12 is opened by the pressure from the ink pack 7, and the sensor chamber 21 returns to a state of ink presence.

In the liquid container 1, when the ink containing amount (liquid containing amount) of the sensor chamber 21 is a predetermined amount or less, the pressure receiving plate 27 defines the detection space serving as the vibration reaction region in cooperation with the ink guide path 33. Accordingly, a frequency of acoustic impedance corresponding to the ink guide path 33 appears. This frequency becomes lower than a frequency by acoustic impedance when the pressure receiving plate 27 is separated from the bottom plate 31, and a difference markedly appears. For this reason, the change of free vibration state to be detected by the piezoelectric sensor 35 markedly appears. Therefore, the time or state where the ink containing amount in the sensor chamber 21 reaches the predetermined level can be accurately and reliably detected.

In the liquid container 1 of this embodiment, the sensor chamber 21 is configured by sealing the opening formed at the top surface with the flexible film 23 that is deformable according to the ink containing amount. Further, the piezoelectric sensor 35 is disposed at the bottom of the sensor chamber 21.

For this reason, the sensor chamber 21 can be easily deformed corresponding to the change of the ink containing amount (change of pressure), and can be easily formed as an airtight space. Therefore, liquid leakage or heat generation can be prevented by a simple structure.

In the liquid container 1 of this embodiment, the pressure receiving plate 27 is fixed to the flexible film 23, and moves by the deformation of the flexible film 23 corresponding to the change of the ink containing amount of the sensor chamber 21. For this reason, with the easy deformation of the flexible film 23, the pressure receiving plate 27 can smoothly follow the liquid level or the pressure.

In the liquid container 1 of this embodiment, the pressure receiving plate 27 has, in the region facing the vibration surface of the piezoelectric sensor 35, the surface substantially parallel to the vibration surface. Therefore, the detection space, the volume of which varies according to the liquid level, can be easily formed.

In the liquid container 1 of this embodiment, the pressure receiving plate 27 is urged in the direction, in which the piezoelectric sensor 35 is disposed, by the compressed coil spring 29 serving as an urging unit formed of an elastic member. For this reason, by adjusting the urging force of the compressed coil spring 29, a time at which the pressure receiving plate 27 defines the detection space in cooperation with the ink guide path 33, can be arbitrarily changed. Therefore, an internal pressure (liquid residual quantity) of the sensor chamber 21 to be detected can be easily set.

In the liquid container 1 of this embodiment, the time at which the pressure receiving plate 27 defines the detection space in cooperation with the ink guide path 33 is set to a state where ink of the ink pack 7 is exhausted. Accordingly, as described above, when the liquid container 1 is used as an ink cartridge, the piezoelectric sensor 35 of the ink detection unit 11 can be effectively used as an ink end detection mechanism for detecting that an ink residual quantity in the ink pack 7 becomes zero.

Further, as shown in FIG. 3, if the inflow of ink from the ink pack 7 to the sensor chamber 21 is blocked by the on/off valve mechanism 12 and the liquid is absorbed from the ink supply port 9, the sensor chamber 21 is in a negative pressure state, and then a minute bubble existing in the sensor chamber 21 is swelled and has a large volume. Therefore, resistance of a flow of ink to be discharged from the ink supply port 9 increases, and the bubble is easily transferred along with ink that flows toward the ink supply port 9.

That is, according to the liquid container 1 of this embodiment, the on/off valve mechanism 12 that is disposed between the ink pack 7 and the sensor chamber 21 so as to block the inflow of ink from the ink pack 7 to the sensor chamber 21 is provided. Accordingly, when the inflow of the liquid from the ink pack 7 to the sensor chamber 21 is blocked by the on/off valve mechanism 12, and the sensor chamber 21 is set in a negative pressure state through the suction of ink from the ink supply port 9, the minute bubble existing in the sensor chamber 21 can be swelled and have a large volume.

Accordingly, resistance against the bubble by the flow of ink to be discharged from the ink supply port 9 can increase, and the bubble can be easily transferred along with ink that flows toward the ink supply port 9.

In a state where the minute bubble is swelled, if ink is supplied from the ink pack 7 to the valve chamber 41 by the pressurization of the ink pack 7 due to pressurized air to be supplied to the pressure chamber 3, the on/off valve mechanism 12 is opened, and ink flows into the sensor chamber 21. Therefore, the bubble is discharged from the ink supply port 9 according to the ink flow. As a result, the minute bubble existing in the sensor chamber 21 can be reliably discharged.

According to the liquid container 1 of this embodiment, when a sufficient ink residual quantity exists in the ink pack 7, the volume of the sensor chamber 21 is increasing regardless of pressurization or unpressurization by the pressure unit. Accordingly, the volume of the sensor chamber 21 is reduced from a time when the inflow of ink from the ink pack 7 stops, that is, when ink is exhausted.

Accordingly, even though pressurization or unpressurization to the ink pack 7 by the pressure unit is repeated according to the supply of ink, the volume of the sensor chamber 21 is not reduced, and the volume of the sensor chamber 21 does not repeatedly change.

Therefore, in the flexible film 23 that constitutes a part of the sensor chamber, wear due to a repetitive change is prevented.

Further, when the on/off valve mechanism 12 that is disposed between the ink pack 7 and the sensor chamber 21 is closed, the inflow of ink from the ink pack 7 is blocked, and thus the ink pack 7 can become a pseudo ink exhaustion state. Therefore, the volume of the sensor chamber 21 can be reduced.

Accordingly, in the liquid container 1 in which the ink pack 7 and the sensor chamber 21 are pressurized simultaneously, while the inkjet recording apparatus is used, if the liquid container 1 becomes the pseudo ink exhaustion state, the change of volume of the sensor chamber 21 can be detected by the piezoelectric sensor 35. Therefore, the malfunction of the piezoelectric sensor 35 can be checked.

That is, while the pressurization is performed by the pressure unit, in a state where the on/off valve mechanism 12 is closed and a state where the on/off valve mechanism is opened, the piezoelectric sensor 35 can detect the volume of the sensor chamber 21. Therefore, it is possible to detect presence/absence of ink in the ink pack 7 and the malfunction of the piezoelectric sensor 35.

According to the above-described liquid container 1 of this embodiment, even though pressurization or unpressurization to the ink pack 7 by the pressure unit is repeated according to the supply of ink, the volume of the sensor chamber 21 is not reduced, and the volume of the sensor chamber 21 does not repeatedly change.

Accordingly, in the flexible film 23 that constitutes a part of the sensor chamber 21, wear due to a repetitive change is prevented. Then, the flexible film 23 does not need to have high durability.

Therefore, since it is not necessary to form the flexible film 23 of an expensive material having high durability, an increase in cost of the liquid container 1 can be prevented. In addition, since it is not necessary to form the flexible film 23 thicker in order to increase durability of the flexible film 23, the flexible film 23 can be easily deformed.

Further, when the on/off valve mechanism 12 that is disposed between the ink pack 7 and the sensor chamber 21 is closed, the inflow of ink from the ink pack 7 is blocked, and thus the ink pack 7 can become the pseudo ink exhaustion state. Therefore, the volume of the sensor chamber 21 can be reduced.

Accordingly, in the liquid container 1 in which the ink pack 7 and the sensor chamber 21 are pressurized simultaneously, while the ink jet recording apparatus is used, if the liquid container 1 becomes the pseudo ink exhaustion state, the change of volume of the sensor chamber 21 can be detected by the piezoelectric sensor 35. Therefore, the malfunction of the piezoelectric sensor 35 can be checked.

That is, while the pressurization is performed by the pressure unit, in a state where the on/off valve mechanism 12 is opened and a state where the on/off valve mechanism 12 is closed, the volume of the sensor chamber 21 is detected by the piezoelectric sensor 35. Accordingly, it is possible to detect presence/absence of ink of the sensor chamber 21 and the malfunction of the piezoelectric sensor 35.

For example, when an ink presence signal is detected in a state where the on/off valve mechanism 12 is opened and an ink absence signal is detected in a state where the on/off valve mechanism 12 is closed, ink exists in the ink pack 7.

Further, when the ink absence signal is detected in a state where the on/off valve mechanism 12 is opened and the ink absence signal is also detected in a state where the on/off valve mechanism 12 is closed, ink does not exist in the ink pack 7.

In addition, when the ink absence signal or the ink presence signal is detected in a state where the on/off valve mechanism 12 is opened and the ink presence signal is detected in a state where the on/off valve mechanism 12 is closed, the piezoelectric sensor 35 malfunctions.

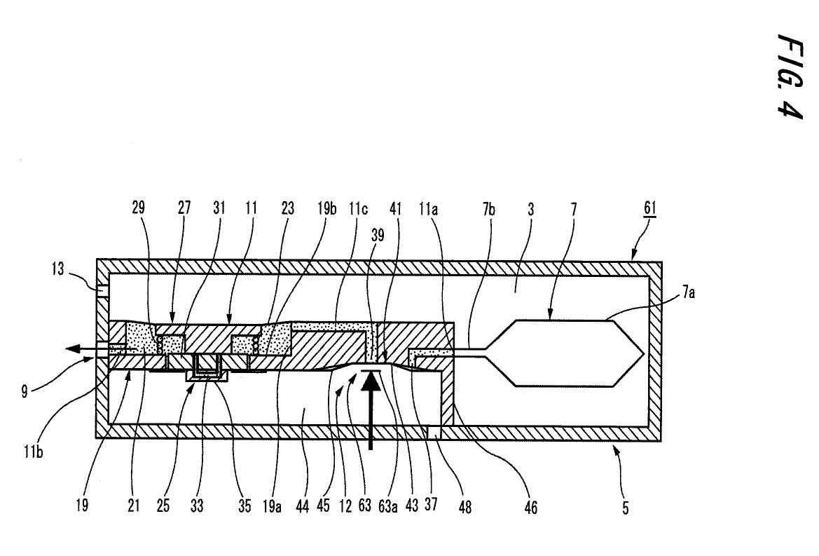

FIG. 4 is a longitudinal cross-sectional view of a liquid container according to a second embodiment of the invention.

A liquid container 61 of the second embodiment changes a part of the liquid container 1 shown in FIG. 1. Specifically, the diaphragm 45 defineing the valve chamber 41 moves by a driving unit 63 that drives a plunger 63a with a fluid pressure or an electromagnetic solenoid.

That is, an external force is applied to the diaphragm 45. The movement of the diaphragm 45 maybe performed by the driving unit 63 or by the cooperation of the external force of the driving unit 63 and the negative pressure according to the suction force from the ink supply port 9 in the above-described embodiment. Moreover, other parts are common to the liquid container 1 shown in FIG. 1. Therefore, the same parts are represented by the same reference numerals, and the descriptions thereof will be omitted.

According to the liquid container 61 of the second embodiment, the diaphragm 45 can be deformed by causing the external force from the driving unit 63 to act on the diaphragm 45 of the on/off valve mechanism 12. Then, the diaphragm 45 comes into close contact with the inlet port 37 and the outlet port 39 formed in the valve chamber 41 by the deformed diaphragm 45 and the negative pressure of the sensor chamber 21 according to the suction of ink from the ink supply port 9. Then, the on/off valve mechanism 12 can be more reliably closed.

The configurations of the liquid containing chamber, the liquid detection chamber, the detection unit, and the on/off valve mechanism in the liquid container of the invention are not limited to the configurations of the above-described embodiments. Various configurations can be adopted on the basis of the spirit of the invention.

For example, in the above-described embodiments, the compressed coil spring 29 is used as an urging unit that urges the flexible film 23 and the pressure receiving plate 27 toward the piezoelectric sensor 35.

However, instead of the compressed coil spring 29, an urging unit formed of a different elastic member may be used.

In the above-described embodiments, the time at which the pressure receiving plate 27 defines the detection space in cooperation with the ink guide path 33 is set to a state where ink of the ink pack 7 is completely exhausted. Then, the piezoelectric sensor 35 functions as an ink end detection mechanism for detecting that the ink residual quantity of the ink pack 7 becomes zero.

However, the time at which the pressure receiving plate 27 defines the detection space in cooperation with the ink guide path 33 may be set to a state where ink of the ink pack 7 is nearly exhausted (a state where a small amount of ink remains). In this case, the piezoelectric sensor 35 can be used as an ink near-end detection mechanism for detecting a state where the ink residual quantity in the ink pack 7 almost becomes zero.

In the liquid container of the invention, the recess portion serving as the vibration reaction region where the detection space is defined and the pressure detection unit applies the vibration is not limited to the ink guide path 33 shown in the above-described embodiments. The recess portion according to the invention may have a simple cutout shape to be formed at the top surface of the bottom plate 31, not a tubular path.

The use of the liquid container according to the invention is not limited to the ink cartridge of the ink jet recording apparatus. For example, the liquid container of the invention is used for various liquid consuming apparatuses having a liquid ejection head that ejects a minute amount of liquid droplet.

Specific examples of the liquid consuming apparatus having a liquid ejection head include an apparatus having a color material ejection head used in manufacturing color filters of a liquid crystal display or the like, an apparatus having an electrode material (conductive paste) ejection head used in forming electrodes of an organic electroluminescent (EL) display or a surface emission display (FED), an apparatus having a bioorganic compound ejection head used in manufacturing a bio-chip, an apparatus having a sample spraying head as a precision pipette, a textile printing apparatus, or a micro dispenser.

What is claimed is:

1. A liquid container comprising:
a liquid containing chamber that discharges a liquid stored therein from a liquid discharge port by pressurization of a pressure unit;
a liquid detection chamber that is disposed in a region where a pressure is applied by the pressure unit and is connected to the liquid containing chamber, a volume of the liquid detection chamber being increased according to an inflow of the liquid from the liquid containing chamber and being reduced when the inflow of the liquid from the liquid containing chamber stops;
a detection unit for detecting a change of the volume of the liquid detection chamber; and
a valve mechanism that is disposed between the liquid containing chamber and the liquid detection chamber and can block an inflow of the liquid from the liquid containing chamber to the liquid detection chamber.

2. The liquid container according to claim 1,
wherein the valve mechanism includes a valve chamber that communicates an inlet port communicating with the liquid containing chamber with an outlet port communicating with the liquid detection chamber, and a diaphragm that defines the valve chamber and is deformable by an external force, and
the outlet port that is formed in the valve chamber is closed by deformation of the diaphragm.

3. The liquid container according to claim 2,
wherein the valve mechanism is disposed in a region that is blocked from a pressure of the pressure unit, and the outlet port formed in the valve chamber is closed by the deformation of the diaphragm according to a negative pressure of the valve chamber generated through suction of the liquid from a supply port.

4. The liquid container according to claim 3,
wherein the outlet port that is formed in the valve chamber has an opening area larger than that of the inlet port that is formed in the valve chamber.

5. The liquid container according to claim 2,
wherein the outlet port that is formed in the valve chamber is disposed to face a maximum displacement portion of the diaphragm.

6. The liquid container according to claim 1,
wherein the liquid detection chamber is configured by sealing an opening of a concave space provided in a member forming the liquid detection chamber with a film that is deformable according to a liquid containing amount.

7. The liquid container according to claim 2,
wherein the diaphragm is formed of a deformable film that seals an opening of a concave place provided in a member forming the valve chamber.

8. The liquid container according to claim 1,
wherein the detection unit includes a moving member that is accommodated to move according to the liquid containing amount of the liquid detection chamber, a recess portion that, if the liquid containing amount of the liquid detection chamber becomes a predetermined amount or less, defines a detection space in cooperation with a surface of the moving member, and a piezoelectric detection unit that applies vibration to the recess portion and detects a free vibration state according to the applied vibration.
